(19) United States
(12) Patent Application Publication
(10) Pub. No.: US 2022/0278598 A1
(43) Pub. Date: Sep. 1, 2022

(54) MOTOR

(71) Applicant: MINEBEA MITSUMI Inc., Nagano (JP)

(72) Inventors: Hirofumi OHBA, Nagano (JP); Minoru KURODA, Nagano (JP); Hiroshi MIYAZAKO, Nagano (JP)

(21) Appl. No.: 17/651,963

(22) Filed: Feb. 22, 2022

(30) Foreign Application Priority Data
Feb. 26, 2021 (JP) 2021-031022

(51) Int. Cl. H02K 23/40; H02K 1/2706; H02K 1/24

(52) U.S. Cl. CPC H02K 23/40; H02K 1/2706; H02K 1/24

(57) ABSTRACT

A motor 1 includes a shaft 2, a rotating body 6 fixed to the shaft 2, a first magnetic body 3 fixed to the shaft 2 and a stationary part including a second magnetic body 4, wherein one of the first magnetic body 3 and the second magnetic body 4 includes a magnet, and the first magnetic body 3 opposes the second magnetic body 4 over an entire circumference.

### CROSS-REFERENCE TO RELATED APPLICATIONS

This application claims the benefit of priority to Japanese Application No. JP2021-031022, filed Feb. 26, 2021, the entire disclosure of which is hereby incorporated herein by reference.

### TECHNICAL FIELD

The present invention relates to a motor.

### BACKGROUND ART

A motor has conventionally been used as a drive source of various devices. There are various types of motors, and a motor to be used is selected in accordance with the purpose or situation.

In a motor used for an information device, onboard unit, or the like, for example, in a motor used in an electric door, an electric hatch gate for a vehicle, or the like, there is a demand to hold a rotating body at a fixed position, and for example, it is desired to suppress rotation of a shaft of the motor when the motor is stopped.

The technology described in Patent Document 1 is a technique for increasing holding torque serving as torque for holding a rotating body at a fixed position. Patent Document 1 describes a technique for a direct current electric motor including four field magnetic poles and an armature iron core including five tooth parts radially extending from a shaft part and opposing the field magnetic poles, and including a groove for increasing an air gap in the center of an open angle at a tip outer circumferential surface of each of the tooth parts of the armature iron core between the field magnetic poles and the tip outer circumferential surface of each of the tooth parts of the armature iron core. Due to the presence of the air gap, when a drive voltage is not applied, an opposing positional relationship between the field magnetic poles and the armature iron core is stable, and the holding torque increases.

### CITATION LIST

### Patent Literature

Patent Document 1: JP 01-91640 A

### SUMMARY OF INVENTION

### Technical Problem

However, in the technology described in Patent Document 1, for example, in a case where a motor shaft is rotated by an external force, when the field magnetic poles and the tooth parts deviate from a stable position, the motor shaft is rotated as is, and thus the position of the rotating body may not be held.

Thus, an object of the present invention of the present application is to provide a motor capable of achieving improved holding torque.

### Solution to Problem

In order to solve the above problem, the present invention employs the following means. Specifically, a motor according to one aspect of the present invention includes a shaft, a rotating body fixed to the shaft, a first magnetic body fixed to the shaft, and a stationary part including a second magnetic body, wherein one of the first magnetic body and the second magnetic body includes a magnet, and the first magnetic body opposes the second magnetic body over an entire circumference.

In the present invention, the first magnetic body and the second magnetic body may oppose each other in a radial direction, and a distance between opposing surfaces of the first magnetic body and the second magnetic body opposing each other may be constant over the entire circumference.

In the present invention, the first magnetic body and the second magnetic body may oppose each other in an axial direction, and opposing surfaces of the first magnetic body and the second magnetic body opposing each other may be flat surfaces.

In any of these cases, the opposing surfaces of the first magnetic body and the second magnetic body may include magnetic pole parts.

The present invention may be configured such that opposing surfaces of the first magnetic body and the second magnetic body include magnetic pole parts, and the first magnetic body urges the shaft in the axial direction by a magnetic force between the first magnetic body and the second magnetic body.

In this case, the present invention may be configured such that the first magnetic body includes a flat surface perpendicular to the axial direction and a sliding member including a sliding surface in contact with the flat surface of the first magnetic body, and the second magnetic body is urged to the sliding member by the magnetic force between the first magnetic body and the second magnetic body.

On the other hand, in the present invention, a frame may be included, each of the opposing surfaces of the first magnetic body and the second magnetic body may include a magnetic pole part, and the second magnetic body may be a second magnet fixed to an inner circumferential surface of the frame. In this case, the second magnet may oppose the rotating body as a member of a stator.

The first magnetic body may be a first magnet and may contain aluminum, nickel, and cobalt, and the second magnetic body may be a second magnet and may contain iron.

The first magnetic body may be disposed at a first end side of the shaft, and an urging member for urging the shaft in the axial direction may be disposed at a second end side of the shaft.

The present invention may be configured to include a fixing member fixed to the shaft and including a flat surface perpendicular to the axial direction and a sliding member including a sliding surface in contact with the flat surface of the fixing member in the axial direction, wherein the urging member urges the sliding member in a direction of the fixing member and thus urges the shaft in the axial direction.

The present invention may be configured such that the first magnetic body is disposed at the first end side of the shaft, and a third magnetic body fixed to the second end side of the shaft and a fourth magnetic body opposing the third magnetic body are included.

In this case, the third magnetic body may be configured to urge the shaft in the axial direction by the magnetic force between the third magnetic body and the fourth magnetic body.

In the present invention, a strength of the magnetic field of one magnetic body among the first magnetic body and the second magnetic body applied to the other magnetic body may be greater than a coercive force of the other magnetic body.

### BRIEF DESCRIPTION OF DRAWINGS

FIG. 1 is a cross-sectional view of a motor according to a first embodiment of the present invention, taken along a section including an axis of a shaft, and is a cross-sectional view taken along C-C in FIG. 2.

FIG. 2 is a cross-sectional view of the motor according to the first embodiment of the present invention, taken along a section perpendicular to the axis of the shaft, and is a cross-sectional view taken along a line A-A in FIG. 1.

FIG. 3 is an enlarged cross-sectional view of a first magnet and the vicinity of the first magnet in the motor according to the first embodiment of the present invention, taken along a section including the axis of the shaft.

FIG. 4 is a cross-sectional view of a motor according to a second embodiment of the present invention, taken along a section including an axis of a shaft, and is a cross-sectional view taken along D-D in FIG. 5.

FIG. 5 is a cross-sectional view of the motor according to the second embodiment of the present invention, taken along a section perpendicular to the axis of the shaft, and is a cross-sectional view taken along a line B-B in FIG. 4.

FIG. 6 is an enlarged cross-sectional view of a first magnet and the vicinity of the first magnet in the motor according to the second embodiment of the present invention, taken along a section including the axis of the shaft.

FIG. 7 is a cross-sectional view of a motor according to a third embodiment of the present invention, taken along a section including an axis of a shaft.

FIG. 8 is a cross-sectional view of a motor according to a fourth embodiment of the present invention, taken along a section including an axis of a shaft.

FIG. 9 is a cross-sectional view of a motor according to a fifth embodiment of the present invention, taken along a section including an axis of a shaft.

FIG. 10 is a cross-sectional view of a motor according to a sixth embodiment of the present invention, taken along a section including an axis of a shaft.

FIG. 11 is a cross-sectional view of a motor according to a seventh embodiment of the present invention, taken along a section including an axis of a shaft.

### DESCRIPTION OF EMBODIMENTS

Several motors according to embodiments being exemplary aspects of the present invention will be described below with reference to the drawings.

### First Embodiment

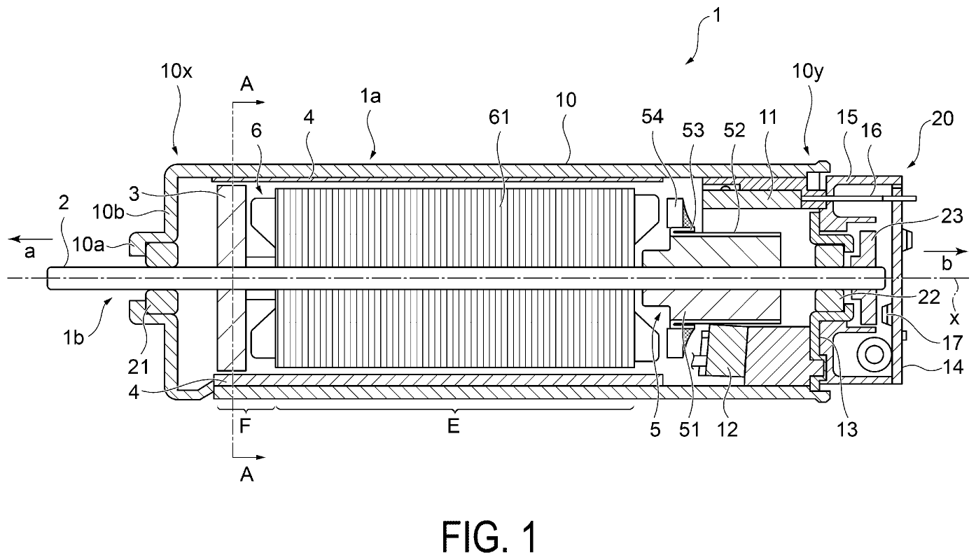

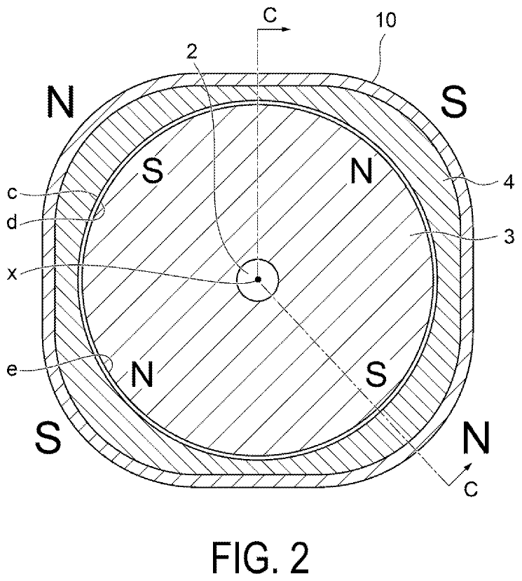

FIG. 1 is a cross-sectional view of a motor 1 according to a first embodiment, taken along a section including an axis x of a shaft 2. FIG. 2 is a cross-sectional view of the motor 1 according to the present embodiment, taken along a section perpendicular to the axis x of the shaft 2. FIG. 1 corresponds to a cross-sectional view taken along C-C in FIG. 2, and FIG. 2 corresponds to a cross-sectional view taken along A-A in FIG. 1. Note that in an axis line x direction (hereinafter, also referred to as “axial direction”), an arrow a direction at a left side is referred to as first side a, and an arrow b direction at a right side is referred to as a second side b (the same applies to all the following embodiments).

As illustrated in FIG. 1, the motor 1 according to the present embodiment includes a housing 1a serving as a stationary part and an armature 1b serving as a rotating body rotatably supported with respect to the housing 1a. The motor 1 is a brush DC motor of a so-called inner rotor type.

Here, “stationary part” refers to a part relatively stationary with respect to the rotating body, and need not be completely stationary. In the present embodiment, the stationary part includes, in addition to a frame 10 and an end plate 13 forming the housing 1a, a second magnet 4, a first bearing part 21, a second bearing part 22, a circuit board 14, a bracket 15, and the like described below.

The motor 1 includes a shaft (rotation axis) 2 rotatably supporting the armature 1b with respect to the housing 1a.

The armature 1b includes a rotor (rotating body) 6, a commutator 5, and the like.

The rotor 6 is fixed to the shaft 2. The rotor 6 includes a rotor core 61 including a plurality of protruding poles (magnetic pole parts) in a radial direction and windings (not illustrated) wound around each of the protruding poles.

The housing 1a is formed of the frame 10 and the end plate 13. A magnet for driving (hereinafter, referred to as “second magnet” or “frame magnet”) 4 opposing an outer circumferential surface of the rotor 6 in the radial direction, a bracket 15 supporting a substrate (circuit board) 14, a brush 12, and the like are attached to the frame 10. The frame magnet 4 is attached to an inner circumferential surface of the frame 10. The protruding poles of the rotor core 61 of the rotor 6 oppose the frame magnet 4.

The frame 10 has a tubular shape with a first end part (referred to as the vicinity of an end part at the first side a in FIG. 1) 10x being closed with the shaft 2 protruding. An opening part of a second end part (referred to as the vicinity of an end part at the second side b in FIG. 1) 10y of the frame 10 is closed by the end plate 13.

The armature 1b is accommodated inside the frame 10, and a second end part 10y of the frame 10 is closed by the end plate 13, and thus the housing 1a accommodating the rotor 6 inside is formed. A part (hereinafter, referred to as “protruding part”) 10a protruding toward an end part at a first end side a of the shaft 2 (toward the first side a) is located at an end part (hereinafter, may be referred to as “bottom part”) 10b at the first end part 10x side of the frame 10, and the first bearing part 21 described later is fixed inside the protruding part 10a. The power of the motor 1 can be externally extracted from the protruding portion of the shaft 2.

The first bearing part 21 is held at a central part of the frame 10 at the first end part 10x as viewed from the axis line x direction. The second bearing part 22 is held at the central part of the end plate 13 as viewed from the axis line x direction. Specifically, the first bearing part 21 is located at a first side of the rotor 6 in the axial direction, and the second bearing part 22 is located at a second side of the rotor 6 in the axial direction. The shaft 2 is axially supported by the first bearing part 21 and the second bearing part 22 (may be collectively referred to as “bearings 21 and 22”) at two locations. The armature 1b is rotatably held with respect to the frame 10 by the bearings 21 and 22.

The commutator 5 is provided at a portion of the shaft 2 located at the end plate 13 side with respect to the rotor 6 (a portion of the shaft 2 at the second side b). The commutator 5 includes a commutator piece 52 at an outer circumferential surface of a support part 51 supporting the commutator, and the commutator piece 52 is connected to the winding wound around the rotor core 61.

A power supply unit 20 includes the end plate 13, the circuit board 14, the bracket 15, the second bearing part 22, the power supply connecting part 11, the brush 12, and the like. The circuit board 14 is mounted outside of the end plate 13 via the bracket 15. The power supply connecting part 11 includes a power supply terminal 16, and an electric current is supplied from the outside by a power supply line connected to the power supply terminal 16.

The brush 12 is electrically connected to the power supply connecting part 11, and a tip end part of the brush 12 is disposed so as to be in contact with an outer circumferential surface of the commutator 5. Electric power is supplied to the commutator piece 52 of the commutator 5 via the brush 12, so that the motor 1 is driven.

An encoder including a disk 23 formed of, for example, a magnet and a sensor 17 such as a Hall sensor is fixed at the end part of the shaft 2 at the second side b. The sensor 17 is mounted at the circuit board 14 at a position opposing the disk 23. For example, magnetic information of the disk 23 is detected by the sensor 17, and thus a rotational state (rotation speed, rotation angle, and the like) of the shaft 2 can be read.

In the present embodiment, the first magnetic body 3 is attached to the shaft 2 at the first side a, and a holding torque is generated between the first magnetic body 3 and the frame magnet (second magnetic body, second magnet) 4. The first magnetic body 3 opposes the frame magnet 4 serving as the second magnetic body over the entire circumference. Specifically, as illustrated in FIG. 2, an outer circumferential surface of the first magnetic body 3 is a curved surface having a constant outer diameter over the entire circumference. The first magnetic body 3 is, for example, a magnet having a disc shape.

The frame magnet 4 and the first magnetic body 3 oppose each other in the radial direction. Each of opposing surfaces of the frame magnet 4 and the first magnetic body 3 opposing each other has a constant diameter over the entire circumference. In particular, the opposing surface of the first magnetic body 3 is an outer circumferential surface, and the opposing surface of the frame magnet 4 is an inner circumferential surface.

The first magnetic body 3 rotates together with the shaft 2 with the axis line x serving as the axis of the shaft 2 as the center axis.

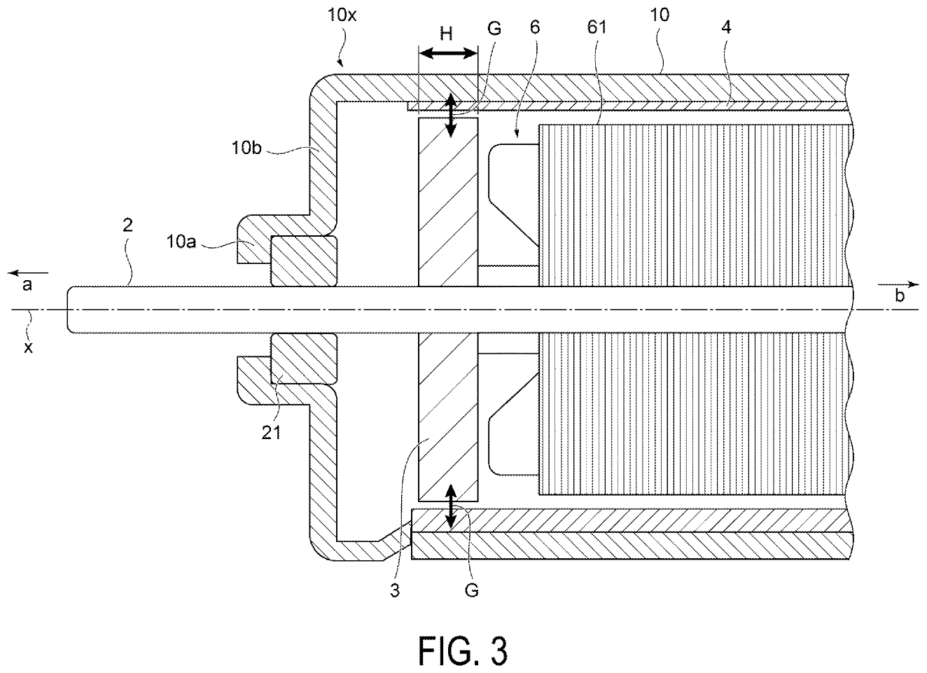

FIG. 3 is an enlarged cross-sectional view of the first magnetic body 3 and the vicinity of the first magnetic body 3 in the motor 1 according to the present embodiment, taken along a section including the axis of the shaft 2.

As illustrated in FIGS. 1 to 3, the outer circumferential surface of the first magnetic body 3 opposes the inner circumferential surface of the frame magnet 4 with a predetermined gap (magnetic gap) in the radial direction.

The inner circumferential surface of a portion of the frame magnet 4 at many regions (region E in FIG. 1) in the axis line x direction opposes the outer circumferential surface of the rotor core 61 in the radial direction. The inner circumferential surface of another portion of the frame magnet 4 at a region (region F in FIG. 1) extending at the first side a in the axis line x direction opposes the outer circumferential surface of the first magnetic body 3 in the radial direction.

In other words, the frame magnet 4 is a member constituting the stator and generates the driving force of the motor 1 by opposing and magnetically acting on the rotor 6. Further, the frame magnet 4 also opposes and magnetically acts on the first magnetic body 3, thus generating a holding torque. Note that the frame magnet 4 corresponds to the “second magnetic body” in the present invention.

The frame magnet 4 is, for example, a ferrite magnet or the like or a ferromagnetic rare earth magnet, and is a permanent magnet having a predetermined magnetic flux density. On the other hand, the first magnet 3 is formed of, for example, a non-oriented steel plate. A coercive force of the first magnetic body 3 is smaller than a strength of a magnetic field applied to the first magnetic body 3 by the frame magnet 4 serving as the second magnet generating the driving force of the motor 1.

As illustrated in FIG. 2, the inner circumferential surface of the frame magnet 4 is magnetized at equal intervals every central angle of 90° so that two magnetic poles (an N pole and an S pole) different from each other alternate in the circumferential direction. Two magnetic poles different from each other are generated at the outer circumferential surface of the first magnetic body 3 in the circumferential direction by the magnetic poles of the frame magnet 4, and the magnetic poles of the first magnetic body 3 and the frame magnet 4 opposing each other are opposite to each other. On the other hand, at the outer circumferential part of the first magnetic body 3 having the small coercive force, a magnetic pole (for example, the S pole at a position d) opposite to a magnetic pole (similarly, the N pole at a position c) of the frame magnet 4 is exhibited at each of positions opposing the frame magnet 4 due to the influence of the magnetic force generated by the frame magnet 4. In other words, opposing surfaces of the first magnetic body and second magnetic body opposing each other in the radial direction include a plurality of magnetic pole parts. As a result, an attractive force (double-headed arrows G in FIG. 3) caused by the magnetic force is generated between the frame magnet 4 and the first magnetic body 3, and the rotation of the first magnetic body 3 together with the shaft 2 is suppressed.

In order to increase the holding torque in the motor, cogging is generally increased. Increasing cogging causes pulsation in the rotation of an axis of the motor. Due to the presence of a peak of the torque (holding torque) in pulsation, the rotation of the shaft of the motor is suppressed and held.

However, in a case where pulsation is large, once a force exceeding the peak of the torque is applied to the shaft by some external force, the force gradually overcomes the peak due to inertia, and the shaft may rotate.

In the present embodiment, a holding torque is generated by a magnetic force (attractive force) generated between the first magnetic body 3 not contributing to the driving force of the motor 1 and the frame magnet 4 corresponding to the second magnet. The motor 1 includes the first magnetic body 3 generating the holding torque, and thus the peak of the holding torque can be increased.

In a case where the coercive force of the first magnetic body 3 is relatively large, because the first magnetic body 3 rotates together with the shaft 2, pulsation (cogging) of the torque may be increased.

A magnet having a small coercive force is used for the first magnetic body 3 in the present embodiment. Thus, even in a case where the shaft 2 rotates due to an external force or the like, the first magnetic body 3 is affected by the magnetic force generated by the frame magnet 4 in the rotational position, and exhibits a magnetic pole opposite to the magnetic pole of the frame magnet 4 at each of positions opposing the frame magnet 4. In other words, the relative arrangement relationship between the magnetic pole of the frame magnet 4 and the magnetic pole exhibited by the first magnetic body 3 does not change, and an attractive force caused by the magnetic force is generated between the frame magnet 4 and the first magnetic body 3.

By using the first magnetic body 3 having a small coercive force, pulsation (cogging) is avoided while increasing the holding torque, and thus the generation of relatively large noise and vibration when the motor 1 is driven can be suppressed. Further, even in the case where an external force is applied, it is possible to prevent the rotor (rotating body) 6 from rotating in accordance with inertia.

Examples of magnetic bodies having a small coercive force suitable for the first magnetic body 3 include so-called electromagnetic steel plates such as silicon steel plates and non-oriented steel plates, and so-called alnico magnets, the alnico magnets being magnets containing aluminum, nickel, and cobalt. On the other hand, examples of magnets having a large coercive force suitable for the second magnet (second magnetic body) include a variety of permanent magnets containing iron.

In the configuration of the present embodiment, a magnitude of the holding torque can be adjusted by not only adjusting the strength of the magnetic force of the frame magnet 4 itself, the frame magnet 4 corresponding to the second magnet, but also by adjusting a thickness of the first magnetic body 3 (that is, an area of the outer circumferential surface of the first magnetic body 3 opposing the second magnet) illustrated as the double-headed arrows H in FIG. 3. In other words, in order to improve the holding torque, the thickness of the first magnetic body 3 may be increased. For example, in the axis line x direction of the motor 1, the thickness of the first magnetic body 3 may be greater than a thickness of each of a plurality of steel plates forming the rotor 6, may be greater than a length from an inner surface (bottom surface) of a bottom part 10b of the frame 10 opposing the first magnetic body 3 to an end part at the arrow a side of the second magnet 4, or may be smaller than a thickness of the commutator 5.

### Second Embodiment

Next, a motor according to a second embodiment as another example of the present invention will be described with reference to the drawings.

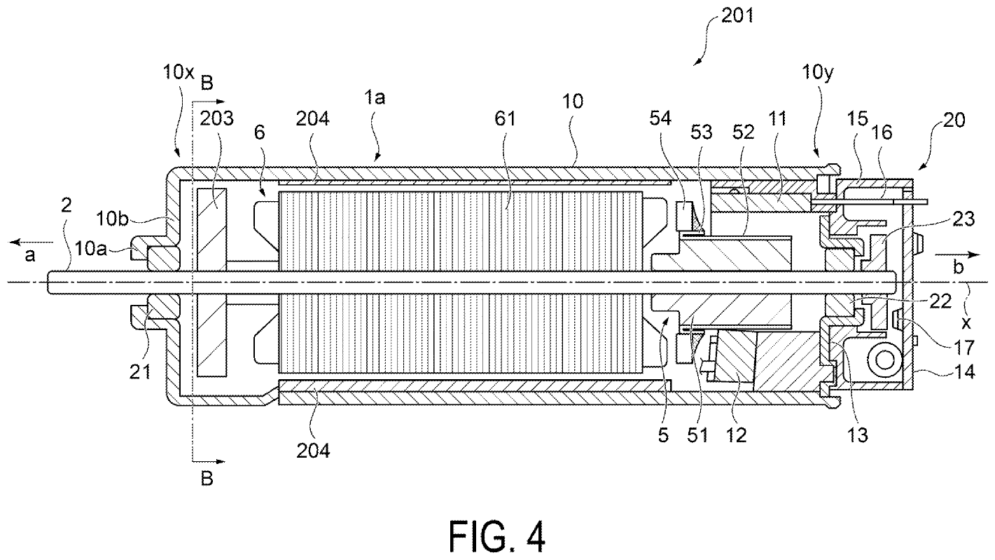

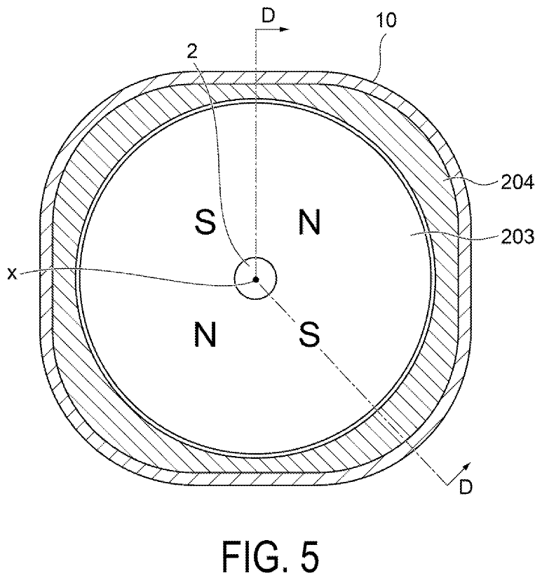

FIG. 4 is a cross-sectional view of a motor 201 according to the second embodiment, taken along a section including an axis x of a shaft 2. FIG. 5 is a cross-sectional view of the motor 201 according to the present embodiment, taken along a section perpendicular to the axis x of the shaft 2. FIG. 4 corresponds to a cross-sectional view taken along D-D in FIG. 5, and FIG. 5 corresponds to a cross-sectional view taken along B-B in FIG. 4.

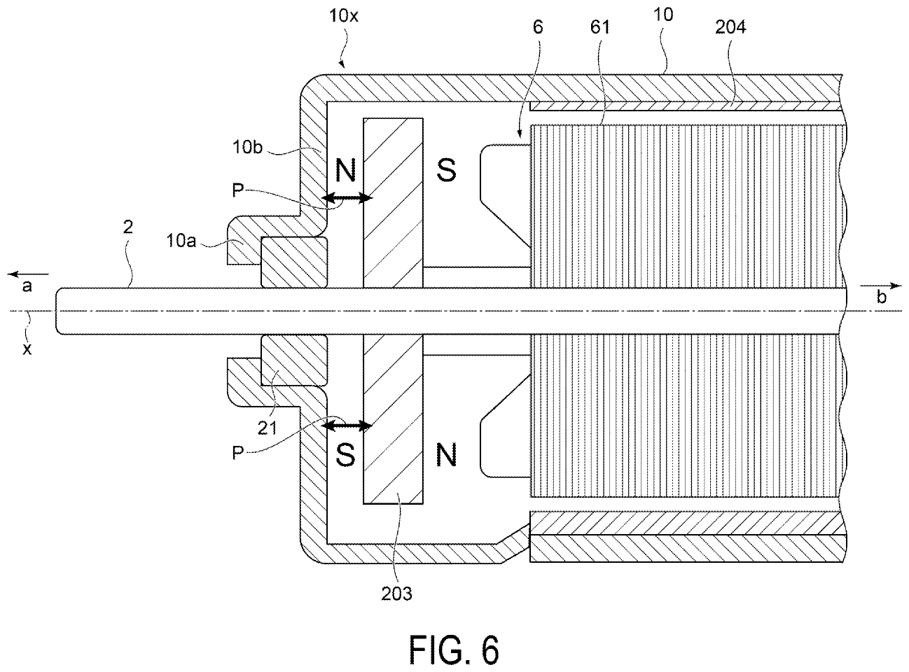

FIG. 6 is an enlarged cross-sectional view of the first magnetic body 203 and the vicinity of the magnetic body 203 in the motor 201 according to the present embodiment, taken along a section including the axis of the shaft 2.

The motor 201 according to the second embodiment has the same configuration as that of the motor 1 according to the first embodiment, except that the structure of the first magnetic body 203 disposed at the first side a of the shaft 2 and the vicinity of the first magnetic body 203 are different. Thus, in the present embodiment, members having the same configuration as those of the first embodiment are given the same reference numerals, and detailed descriptions of the members will be omitted.

In the present embodiment, the first magnetic body 203 for generating a holding torque is attached to the motor 201 at the first side a of the shaft 2. As illustrated in FIG. 5, the outer circumferential surface of the first magnetic body 203 is a magnet having a disc shape with a constant outer diameter, curved over the entire circumference. The first magnetic body 203 rotates together with the shaft 2 with the axis line x serving as the axis of the shaft 2 as the center axis.

The first magnetic body 203 is disposed at a position closer to the first side a than the first magnetic body 3 in the first embodiment, and specifically, is disposed at a position close to an inner surface of the bottom part 10b of the frame 10. In other words, the first magnetic body 203 and the inner surface of the bottom part 10b oppose each other in the axial direction.

The first magnetic body 203 and the bottom part 10b of the frame 10 oppose each other over the entire circumference of the end surface of the first magnetic body at the first side a in the axial direction. Opposing surfaces of the first magnetic body 203 and the bottom part 10b of the frame 10 opposing each other are flat surfaces.

The frame 10 is formed of a steel plate serving as a magnetic body, and a magnetic force acts between the first magnetic body 203 and the bottom part 10b of the frame 10, thus generating the holding torque. Thus, in the present embodiment, the bottom part 10b of the frame 10 corresponds to the “second magnetic body” in the present invention.

The first magnetic body 203 is, for example, a permanent magnet having a relatively large magnetic flux density, such as a ferrite magnet, a rare earth magnet, or the like. On the other hand, the frame 10 formed of a steel plate has a coercive force smaller than the strength of the magnetic field applied to the bottom part 10b of the frame 10 by the first magnetic body 203.

As illustrated in FIG. 6, the first magnetic body 203 is magnetized so as to include two magnetic poles (S pole and N pole) different from each other in the thickness direction (same as the axis line x direction). Thus, the opposing surfaces of the first magnetic body 203 and the second magnetic body (the bottom part 10b of the frame 10) include a plurality of magnetic pole parts in the axial direction.

As illustrated in FIG. 5, the surface of the first magnetic body 203 opposing the inner surface of the bottom 10b of the frame 10 is magnetized at equal intervals every central angle of 90°, so that two magnetic poles (an N pole and an S pole) different from each other alternate in the circumferential direction. On the other hand, the inner surface of the bottom part 10b of the frame 10 opposing the first magnetic body 203 includes a magnetic pole opposite to a magnetic pole of the first magnetic body 203. In other words, the first magnetic body 203 and the inner surface of the bottom part 10b of the frame 10 opposing each other in the axial direction include a plurality of magnetic pole parts. As a result, an attractive force (double-headed arrows P in FIG. 6) caused by the magnetic force is generated between the first magnetic body 203 and the inner surface of the bottom part 10b of the frame 10, and thus movement of the first magnetic body 203 in the rotational direction is suppressed.

In the present embodiment, a holding torque is generated by the magnetic force (attractive force) generated between the first magnetic body 203 not contributing to the driving force of the motor 201 and the inner surface of the bottom part 10b of the frame 10. The motor 201 includes the first magnetic body 203 generating the holding torque, and thus the peak of the holding torque can be increased.

In the present embodiment, the strength of the magnetic field of the first magnetic body 203 is greater than a coercive force of the bottom part 10b of the frame 10 formed of a steel plate.

Thus, the inner surface of the bottom part 10b of the frame 10 opposing the first magnetic body 203 directly becomes a magnetic pole having a polarity opposite to that of the first magnetic body 203, and a magnetic force (attractive force) is generated between the first magnetic body 203 and the inner surface of the bottom part 10b of the frame 10. Accordingly, the rotation of the first magnetic body 203 is suppressed together with rotation of the shaft 2. Thus, generation of a relatively large pulsation (cogging) can be suppressed, generation of noise and vibration when the motor 201 is driven can be suppressed, and the rotor (rotating body) 6 can be prevented from rotating in accordance with inertia even when an external force is applied.

### Third Embodiment

Next, a motor according to a third embodiment as another example of the present invention will be described with reference to the drawings.

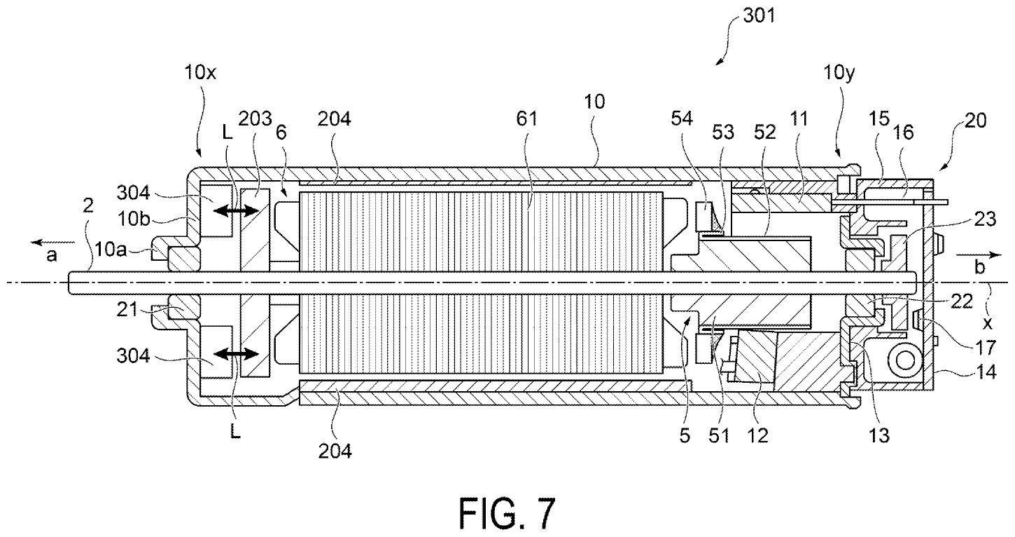

FIG. 7 is a cross-sectional view of a motor 301 according to the third embodiment, taken along a section (section cut out in a fan shape similar to the first embodiment and corresponding to the section taken along C-C illustrated in FIG. 2) including an axis x of a shaft 2. Note that in the present embodiment, a cross-sectional view taken along the section perpendicular to the axis x of the shaft 2 is omitted, but in practice, the cross-sectional view is the same as that in FIG. 5 in the second embodiment, and thus reference should be made to FIG. 5.

The motor 301 according to the third embodiment has the same configuration as that of the motor 1 according to the first embodiment, except that the structure of the vicinity of the first magnetic body 203 disposed at the first side a of the shaft 2 is different. Thus, in the present embodiment, members having the same configuration as those of the first embodiment are given the same reference numerals, and detailed descriptions of the members will be omitted. Since the first magnetic body 203 has the same configuration as that of the second embodiment, the same reference numeral 203 as in the second embodiment is given, and detailed descriptions of the members will be omitted.

In the present embodiment, a magnetic member 304 having a ring shape is attached to the motor 301 at the inner surface of the bottom part 10b of the frame 10. The magnetic member 304 is disposed to oppose the first magnetic body 203, and magnetically acts with respect to the first magnetic body 203, and generates a holding torque. Thus, in the present embodiment, the magnetic member 304 corresponds to the “second magnetic body” in the present invention.

The first magnetic body 203 and the magnetic member 304 oppose each other in the axial direction. The first magnetic body 203 and the magnetic member 304 oppose each other over the entire circumference in the axial direction. Opposing surfaces of the first magnetic body 203 and the magnetic member 304 opposing each other are flat surfaces.

The first magnetic body 203 is, for example, a permanent magnet having a relatively large magnetic flux density, such as a ferrite magnet, a rare earth magnet, or the like. A coercive force of the magnetic member 304 is smaller than the strength of a magnetic field applied to the magnetic member 304 by the first magnetic body 203.

Similar to the second embodiment, as illustrated in FIG. 5, the surface of the first magnetic body 203 opposing the magnetic member 304 is magnetized at equal intervals every central angle of 90° so that two magnetic poles (an N pole and an S pole) different from each other alternate in the circumferential direction. On the other hand, the magnetic member 304 includes a magnetic pole opposite to the magnetic pole of the first magnetic body 203. In other words, the opposing surfaces of the first magnetic body 203 and the magnetic member 304 opposing each in the axial direction other include a plurality of magnetic pole parts. As a result, an attractive force (double-headed arrows L in FIG. 7) caused by a magnetic force is generated between the first magnetic body 203 and the magnetic member 304, and thus movement of the first magnetic body 203 in the rotational direction is suppressed.

In the present embodiment a holding torque is generated by the magnetic force (attractive force) generated between the first magnetic body 203 not contributing to the driving force of the motor 301 and the magnetic member 304. The motor 301 includes the first magnetic body 203 and the magnetic member 304 generating the holding torque, and thus the peak of the holding torque can be increased.

In the present embodiment, the strength of the magnetic field of the first magnetic body 203 is greater than the coercive force of the magnetic member 304.

Thus, the magnetic member 304 opposing the first magnetic body 203 becomes a magnetic pole having a polarity opposite to that of the first magnetic body 203, and thus a magnetic force (attractive force) is generated between the first magnetic body 203 and the magnetic member 304. Accordingly, the rotation of the first magnetic body 203 is suppressed together with the shaft 2. Thus, generation of pulsation (cogging) can be suppressed, generation of noise and vibration when the motor 301 is driven can be suppressed, and the rotor (rotating body) 6 can be prevented from rotating in accordance with inertia even when an external force is applied.

Note that the strength of the magnetic field of the magnetic member 304 may be greater than a coercive force of the first magnetic body 203. In this case, a first surface of the magnetic member 304 opposing the inner surface of the bottom part 10b of the frame 10 and a second surface of the magnetic member 304 opposing the first magnetic body 203 (surface at the first side a and surface at the second side b) are magnetized into two magnetic poles (an N pole and an S pole) different from each other. In this case, the magnetic member 304 is a permanent magnet having a large coercive force, such as a ferrite magnet, a rare earth magnet, or the like, and the coercive force of the first magnetic body 203 is smaller than the strength of the magnetic field applied to the first magnetic body 203 by the magnetic member 304.

### Fourth Embodiment

Next, a motor according to a fourth embodiment as another example of the present invention will be described with reference to the drawings.

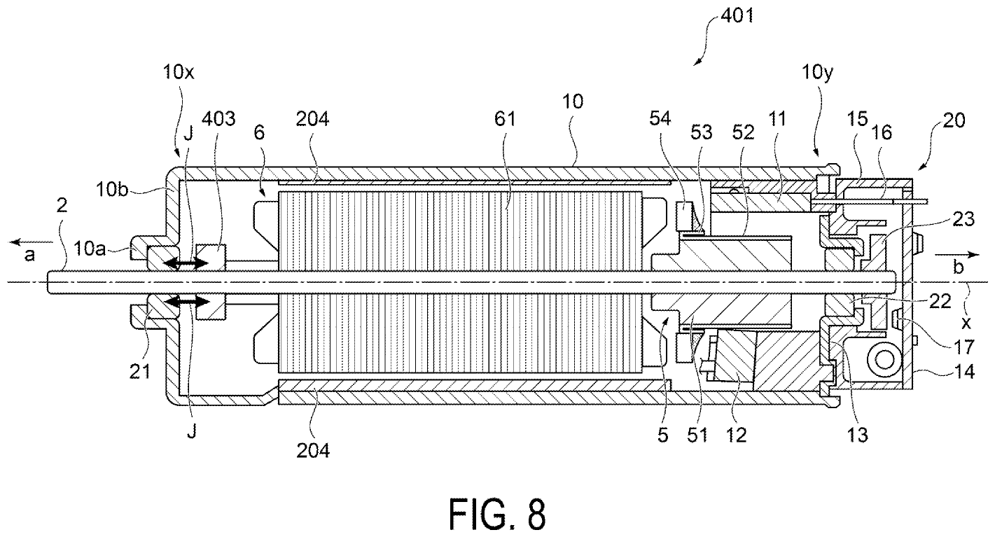

FIG. 8 is a cross-sectional view of a motor 401 according to the fourth embodiment, taken along a section (section cut out in a fan shape similar to the first embodiment and corresponding to the section taken along C-C illustrated in FIG. 2) including an axis x of the shaft 2.

The motor 401 according to the fourth embodiment has the same configuration as that of the motor 1 according to the first embodiment, except that the structure of the first magnetic body 403 disposed at the first side a of the shaft 2 and the vicinity of the first magnetic body 403 are different. Thus, in the present embodiment, members having the same configuration as those of the first embodiment are given the same reference numerals, and detailed descriptions of the members will be omitted.

In the present embodiment, the first magnetic body 403 for generating a holding torque is attached to the motor 401 at the first side a of the shaft 2. The first magnetic body 403 is a magnet having a disc shape and having a smaller outer diameter than that of the first magnetic body 203 in the second embodiment, and rotates together with the shaft 2 with the axis line x serving as the axis of the shaft 2 as the center axis.

Similar to the first magnetic body 203 in the second embodiment, the first magnetic body 403 is disposed at a position close to an inner surface of the bottom part 10b of the frame 10. However, in the present embodiment, an outer diameter of the first magnetic body 403 is small, and opposes the first bearing part 21 supported by the protruding part 10a of the frame 10. The first bearing part 21 is formed of a sintered member containing iron serving as a magnetic body. The first magnetic body 403 and the first bearing part 21 magnetically interact with each other, thus generating a holding torque. Thus, in the present embodiment, the first bearing part 21 corresponds to the “second magnetic body” in the present invention.

The first magnetic body 403 and the first bearing part 21 oppose each other in the axial direction. The first magnetic body 403 and the first bearing part 21 oppose each other over the entire circumference in the axial direction. Opposing surfaces of the first magnetic body 403 and the first bearing part 21 opposing each other are flat surfaces.

The first magnetic body 403 is a permanent magnet having a relatively large magnetic flux density, such as a ferrite magnet, a rare earth magnet, or the like. The first bearing part 21 has a coercive force smaller than the strength of the magnetic field applied by the first magnetic body 403.

Similar to the first magnetic body 203 of the second embodiment, the first magnetic body 403 is magnetized into two magnetic poles (S pole and N pole) different from each other in a thickness direction (same as the axis line x direction). The first magnetic body 403 has an outer diameter different from that of the first magnetic body 203 in the second embodiment.

A surface (hereinafter, referred to as “opposing surface”) of the first bearing part 21 at the second side b opposing the first magnetic body 403 includes a magnetic pole opposite to a magnetic pole of the first magnetic body 403. The opposing surfaces of the first magnetic body 403 and the first bearing part 21 opposing each other in the axial direction include a plurality of magnetic pole parts. As a result, an attractive force (double-headed arrows J in FIG. 8) caused by a magnetic force is generated between the opposing surfaces of the first magnetic body 403 and the first bearing part 21, and thus movement of the first magnetic body 403 in the rotational direction is suppressed.

In the present embodiment a holding torque is generated by a magnetic force (attractive force) generated between the first magnetic body 403 not contributing to the driving of the motor 401 and the first bearing part 21. The motor 401 includes the first magnetic body 403 generating the holding torque, and thus the peak of the holding torque can be increased.

In the present embodiment, the strength of the magnetic field applied to the first bearing part 21 by the first magnetic body 403 is greater than a coercive force of the first bearing part 21.

Thus, the first bearing part 21 opposing the first magnetic body 403 becomes a magnetic pole having an opposite polarity to the first magnetic body 403, and a magnetic force (attractive force) is generated between the first magnetic body 403 and the first bearing part 21. Accordingly, rotation of the first magnetic body 403 is suppressed together with the shaft 2. Thus, generation of pulsation (cogging) can be suppressed, generation of noise and vibration when the motor 401 is driven can be suppressed, and the rotor (rotating body) 6 can be prevented from rotating in accordance with inertia even when an external force is applied.

### Fifth Embodiment

Next, a motor according to a fifth embodiment as another example of the present invention will be described with reference to the drawings.

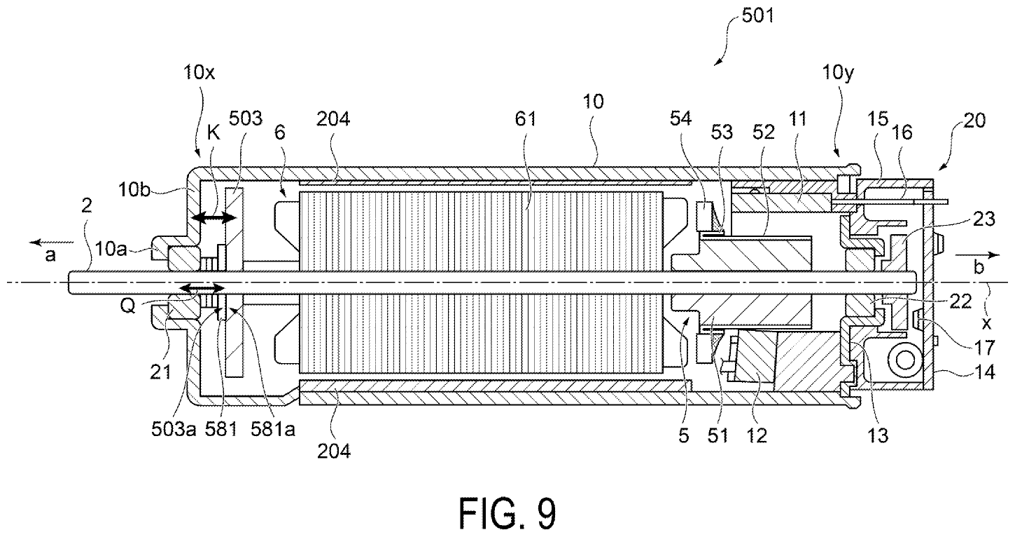

FIG. 9 is a cross-sectional view of a motor 501 according to the fifth embodiment, taken along a section (section cut out in a fan shape similar to the first embodiment and corresponding to the section taken along C-C illustrated in FIG. 2) including an axis x of the shaft 2. Note that in the present embodiment, a cross-sectional view taken along a section perpendicular to the axis x of the shaft 2 is omitted, but the magnetization state of a first magnetic body 503 is the same as that of the first magnetic body 203 in the second embodiment, and thus reference should be made to FIG. 5.

The motor 501 according to the fifth embodiment has the same configuration as that of the motor 1 according to the first embodiment, except that the structure of the first magnetic body 503 disposed at the first side a of the shaft 2 and the vicinity of the first magnetic body 503 are different. Thus, in the present embodiment, members having the same configuration as those of the first embodiment are given the same reference numerals, and detailed descriptions of the members will be omitted.

In the present embodiment, the first magnetic body 503 for generating a holding torque is attached to the motor 501 at the first side a of the shaft 2. The first magnetic body 503 is a magnet having a disc shape and having a constant outer diameter smaller than a thickness of the first magnetic body 203 in the second embodiment, and rotates together with the shaft 2 with the axis line x serving as the axis of the shaft 2 as the center axis.

Similar to the first magnetic body 203 in the second embodiment, the first magnetic body 503 is disposed at a position close to the bottom part 10b of the frame 10. In other words, the first magnetic body 503 and the bottom part 10b of the frame 10 oppose each other. The frame 10 is formed of a steel plate serving as the magnetic body. The first magnetic body 503 and the bottom part 10b of the frame 10 magnetically interact with each other, thus generating a holding torque. Thus, in the present embodiment, the bottom part 10b of the frame 10 corresponds to the “second magnetic body” in the present invention.

The first magnetic body 503 and the inner surface of the bottom part 10b of the frame 10 oppose each other in the axial direction. The first magnetic body 503 and the inner surface of the bottom part 10b of the frame 10 oppose each other over the entire circumference in the axial direction. The first magnetic body 503 and the inner surface of the bottom part 10b of the frame 10 opposing each other are flat surfaces.

The first magnetic body 503 is a permanent magnet having a relatively large magnetic flux density, such as a ferrite magnet, a rare earth magnet, or the like. On the other hand, the frame 10 formed of a steel plate has a coercive force smaller than the strength of the magnetic field applied to the bottom part 10b of the frame 10 by the first magnetic body 503.

Similar to the second embodiment, as illustrated in FIG. 5, a surface of the first magnetic body 503 opposing the inner surface of the bottom part 10b of the frame 10 of the first magnetic body 503 is magnetized at equal intervals every central angle of 90° so that two magnetic poles (N pole and S pole) different from each other alternate in the circumferential direction. On the other hand, the inner surface of the bottom part 10b of the frame 10 opposing the first magnetic body 503 includes a magnetic pole opposite to a magnetic pole of the first magnetic body 503. In other words, the first magnetic body 503 and the inner surface of the bottom part 10b of the frame 10 opposing each other in the axial direction include a plurality of magnetic pole parts. As a result, an attractive force (double-headed arrows K in FIG. 9) caused by a magnetic force is generated between the first magnetic body 503 and the inner surface of the bottom part 10b of the frame 10, and thus movement of the first magnetic body 503 in the rotational direction is suppressed.

In the present embodiment, a washer serving as a sliding member (hereinafter referred to as “loose washer”) 581 is provided between the first bearing part 21 and the first magnetic body 503. The loose washer 581 includes a plurality of the washers being stacked and is penetrated by the shaft 2. A surface of the loose washer 581 at the first side a is in contact with the first bearing part 21.

The first bearing part 21 in the present embodiment is a sintered impregnated bearing, but may be formed of a material containing a magnetic body such as iron, or a bearing having another structure such as a rolling bearing or another sliding bearing may be used. Note that, in a case where the rolling bearing including an inner ring and an outer ring is used as the first bearing part 21, the surface of the loose washer 581 at the first side a comes into contact with the outer ring fixed to the bottom part 10b of the frame 10 and not rotating together with the shaft 2.

On the other hand, a surface of the loose washer 581 at the second side b is in contact with a surface (surface perpendicular to the axis line x direction) 503a of the first magnetic body 503 at the first side a as a sliding surface 581a.

Since the inner surface of the bottom part 10b of the frame 10 opposing the first magnetic body 503 is the magnetic body (the second magnetic body), an attractive force caused by a magnetic force is generated between the first magnetic body 503 and the inner surface of the bottom part 10b of the frame 10. Thus, the first magnetic body 503 is attracted by the magnetic force (attractive force) between the first magnetic body 503 and the inner surface of the bottom part 10b of the frame 10, and the first magnetic body 503 is urged (double-headed arrows Q in FIG. 9) to the loose washer 581.

As a result, when the first magnetic body 503 rotates together with the shaft 2, friction is generated between the sliding surface 581a and the surface 503a at the first side a, due to the urging force generated between the surface 503a of the first magnetic body 503 at the first side a and the sliding surface 581a of the loose washer 581, and a holding torque is generated. Thus, rotation of the shaft 2 together with the first magnetic body 503 is suppressed. With this configuration, pulsation (cogging) is not increased, and it is possible to suppress generation of noise and vibration when the motor 501 is driven, and to prevent the rotor (rotating body) 6 from rotating in accordance with inertia even when an external force is applied.

Accordingly, in the present embodiment, the holding torque of the motor 501 is further improved by a combination of the holding torque due to the attractive force (double-headed arrows K in FIG. 9) caused by the magnetic force between the first magnetic body 503 and the inner surface of the bottom 10b of the frame 10, and the holding torque due to the friction force between the sliding surface 581a of the loose washer 581 and the surface 503a of the first magnetic body 503 at the first side caused by the urging force (double-headed arrows Q in FIG. 9).

Note that in the present embodiment, since a large holding torque is obtained due to the friction force between the first magnetic body 503 and the loose washer 581, the attractive force (double-headed arrows K in FIG. 9) caused by the magnetic force generated between the first magnetic body 503 and the inner surface of the bottom part 10b of the frame 10 may be small.

In other words, in the present embodiment, unlike the first magnetic body 203 illustrated in FIG. 5, two magnetic poles (N pole and S pole) different from each other need not be magnetized so as to alternate in the circumferential direction. Accordingly, in the first magnetic body 503, even in a case where the surface at the first side a (in other words, the flat surface 503a) and the surface at the second side b are respectively uniform magnetic poles in the thickness direction (the same as the axis line x direction), a friction force is generated between the flat surface 503a of the first magnetic body 503 and the sliding surface 581a of the loose washer 581, and thus a holding torque can be obtained due to the friction force.

### Sixth Embodiment

Next, a motor according to a sixth embodiment will be described as another example of the present invention with reference to the drawings.

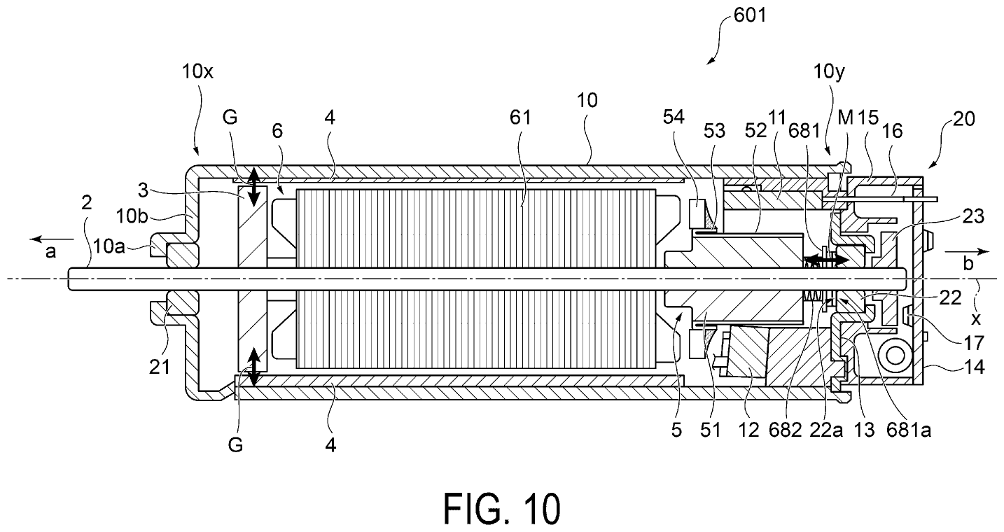

FIG. 10 is a cross-sectional view of a motor 601 according to the sixth embodiment, taken along a section (section cut out in a fan shape similar to the first embodiment and corresponding to the section taken along C-C illustrated in FIG. 2) including an axis x of the shaft 2. Note that in the present embodiment, a cross-sectional view taken along a section perpendicular to the axis x of the shaft 2 is omitted, but in practice, the cross-sectional view is the same as that in FIG. 2 in the first embodiment, and thus reference should be made to FIG. 2.

The motor 601 according to the sixth embodiment has the same configuration as that of the motor 1 according to the first embodiment, except that the structure of the vicinity of the second bearing part 22 disposed at the second side b of the shaft 2 is different. Thus, in the present embodiment, members having the same configuration as those of the first embodiment are given the same reference numerals, and detailed descriptions of the members will be omitted.

In the present embodiment, the motor 601 is provided with a loose washer 681 serving as a sliding member, and a spring having a coil shape (hereinafter referred to as “coil spring”) 682 serving as an urging member between the second bearing part 22 disposed at the second side b of the shaft 2 and the commutator 5.

The loose washer 681 includes a plurality of washers being stacked and is penetrated by the shaft 2.

With the shaft 2 penetrating through a hole part of the coil spring 682, a portion of the coil spring 682 at the first side a is in contact with the support part 51 of the commutator 5, and another portion of the coil spring 682 at the second side b is in contact with a surface of the loose washer 681 at the first side a.

The coil spring 682 attempts to extend between the commutator 5 and the loose washer 681 by a restoring force from a compressed state. The restoring force acts so as to increase the distance between the commutator 5 and the loose washer 681. In other words, the coil spring 682 urges the loose washer 681 from the first side a toward the second side b by the restoring force.

In the loose washer 681, the surface at the second side b serves as the sliding surface 681a and is in contact with a surface (surface perpendicular to the axis line x direction) 22a of the second bearing part 22 at the first side a.

The second bearing part 22 in the present embodiment is a sintered impregnated bearing, but may be formed of a material containing a magnetic body such as iron, or a bearing having another structure such as a rolling bearing or another sliding bearing may be used. Note that, in a case where the rolling bearing including the inner ring and the outer ring is used as the second bearing part 22, the sliding surface 681a comes into contact with the outer ring fixed to the end plate 13 and not rotating together with the shaft 2.

The coil spring 682 urges the loose washer 681 toward the second side b (the direction of the second bearing part 22), thus urging (double-headed arrows M in FIG. 10) the loose washer 681 to the second bearing part 22.

Thus, in a case where the commutator 5 attempts to rotate together with the shaft 2, the sliding surface 681a of the loose washer 681 is urged to the flat surface 22a of the second bearing part 22, and a friction force is generated between the sliding surface 681a and the flat surface 22a, and thus rotation of the shaft 2 is suppressed. With this configuration, pulsation (cogging) is not increased, and it is possible to suppress generation of noise and vibration when the motor 601 is driven, and to prevent the rotor (rotating body) 6 from rotating in accordance with inertia even when an external force is applied.

Accordingly, in the present embodiment, the holding torque is further improved by a combination of the holding torque due to the magnetic force (attractive force, double-headed arrows G in FIG. 10) generated between the magnetic body 3 and the frame magnet 4 and the holding torque due to the friction force between the sliding surface 681a of the loose washer 681 and the flat surface 22a of the second bearing part 22. In other words, the motor 601 of the present embodiment is configured to generate the holding torque at both the first side a and the second side b of the shaft 2. Thus, it is possible to suppress a force for suppressing the rotation of the shaft 2 acting only on one side in the rotation axis direction and thus acting in the twisting direction with respect to the shaft 2.

### Seventh Embodiment

Next, a motor according to a seventh embodiment will be described as another example of the present invention with reference to the drawings.

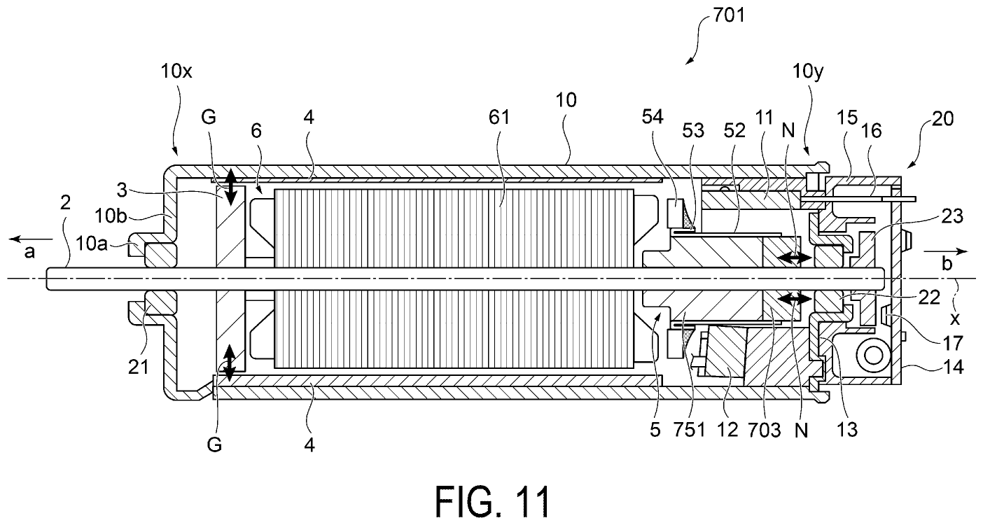

FIG. 11 is a cross-sectional view of a motor 701 according to the seventh embodiment, taken along a section (section cut out in a fan shape similar to the first embodiment and corresponding to the section taken along C-C illustrated in FIG. 2) including an axis x of the shaft 2. Note that in the present embodiment, a cross-sectional view taken along a section perpendicular to the axis x of the shaft 2 is omitted, but in practice, the cross-sectional view is the same as that in FIG. 2 in the first embodiment, and thus reference should be made to FIG. 2.

The motor 701 according to the seventh embodiment has the same configuration as that of the motor 1 according to the first embodiment, except that the structure of the vicinity of the second bearing part 22 disposed at the second side b of the shaft 2 is different. Thus, in the present embodiment, members having the same configuration as those of the first embodiment are given the same reference numerals, and detailed descriptions of the members will be omitted.

In the present embodiment, in the motor 701, a length of a support part 751 of the commutator 5 in the axis line x direction is shorter than that of the support part 51 in the first embodiment, and a third magnetic body 703 for generating a holding torque is attached at the second side b of the support part 751. As illustrated in FIG. 11, the third magnetic body 703 is a magnet having a disc shape and having a relatively large thickness and a constant outer diameter in the axis line x direction, and rotates together with the shaft 2 with the axis line x serving as the axis of the shaft 2 as the center axis.

The third magnetic body 703 is disposed with the surface of third magnetic body 703 at the second side b being close to the second bearing part 22. In other words, the surface of the third magnetic body 703 at the second side b opposes the surface of the second bearing part 22 at the first side a and a partial region of the end plate 13. The first bearing part 21 is formed of the sintered member containing iron serving as the magnetic body. The end plate 13 is also formed of a steel plate serving as the magnetic body. Thus, the third magnetic body 703, the second bearing part 22 and a partial region of the end plate 13 (hereinafter, referred to as “second bearing part 22 and the like”) magnetically interact with each other, thus generating a holding torque. Thus, in the present embodiment, the second bearing part 22 and the like correspond to the “fourth magnetic body” in the present invention.

The third magnetic body 703 and the second bearing part 22 and the like oppose each other in the axial direction. The third magnetic body 703 and the second bearing part 22 and the like oppose each other over the entire circumference in the axial direction. The opposing surfaces of the third magnetic body 703 and the second bearing part 22 and the like opposing each other are flat surfaces.

The third magnetic body 703 is a permanent magnet having a relatively large magnetic flux density, such as a ferrite magnet, a rare earth magnet, or the like. On the other hand, the second bearing part 22 and the like have a coercive force smaller than the strength of the magnetic field applied to the second bearing part 22 by the third magnetic body 703.

Similar to the first magnetic body 203 of the second embodiment, the third magnetic body 703 is magnetized into two magnetic poles (S pole and N pole) different from each other in a thickness direction (same as the axis line x direction). The third magnetic body 703 has an outer diameter and a thickness different from those of the first magnetic body 203 in the second embodiment.

A surface (hereinafter, referred to as “opposing surface”) of the second bearing part 22 and the like having a small coercive force at the first side a include a magnetic pole opposite to the magnetic pole of the third magnetic body 703. Opposing surfaces of the third magnetic body 703 and the second bearing part 22 and the like opposing each other in the axial direction include a plurality of the magnetic pole parts. As a result, an attractive force (double-headed arrows N in FIG. 11) caused by a magnetic force is generated between the opposing surfaces of third magnetic body 703 and the second bearing part 22 and the like, and the movement of the third magnetic body 703 in the rotational direction is suppressed, and thus rotation of the third magnetic body 703 together with the shaft 2 is suppressed.

In the third magnetic body 703, similar to the first magnetic body 403 of the fourth embodiment, a holding torque is generated at the second side b of the shaft 2, by the magnetic force (attractive force) generated between the third magnetic body 703 not contributing to the driving of the motor 701 and the first bearing part 22 and the like. The motor 701 includes the third magnetic body 703 generating the holding torque, and thus the peak of the holding torque can be increased.

In the present embodiment, the strength of the magnetic field applied to the second bearing part 22 and the like by the third magnetic body 703 is greater than the coercive force of the second bearing part 22 and the like.

Thus, the second bearing part 22 and the like opposing the third magnetic body 703 include magnetic poles having a polarity opposite to those of the third magnetic body 703. Accordingly, rotation of the third magnetic body 703 can be suppressed. An increase in pulsation (cogging) can be suppressed, and it is possible to suppress generation of noise and vibration when the motor 701 is driven and to prevent the rotor (rotating body) 6 from rotating in accordance with inertia even when an external force is applied.

Accordingly, in the present embodiment, the attractive force (double-headed arrows N in FIG. 11) caused by the magnetic force generated between the third magnetic body 703 and the second bearing part 22 and the like is combined with the attractive force (double-headed arrows Gin FIG. 11) caused by the magnetic force generated between the first magnetic body 3 and the frame magnet 4, and thus the holding torque is further improved. In other words, the motor 701 of the present embodiment is configured to generate the holding torque at both the first side a and the second side b of the shaft 2. Thus, it is possible to suppress a force for suppressing the rotation of the shaft 2 acting only on one side in the axis line x direction and thus acting in a twisting direction with respect to the shaft 2.

As described above, the motor according to the present invention has been described with reference to preferred embodiments; however, as shown in each of the embodiments described above, by using a structure in which a plurality of magnetic bodies oppose each other, for example, at least one magnetic body includes a magnet as in the first magnetic body and the second magnetic body, the other magnetic body is attracted by the magnetic force of the magnet included in the one magnetic body, and thus a holding torque can be generated.

In this case, the other magnetic body is formed of a material having a coercive force smaller than the strength of the magnetic field exerted on the other magnetic body by the one magnetic body such as an electromagnetic steel plate or an alnico magnet, in other words, the strength of the magnetic field applied to the other magnetic body by the one magnetic body among the first magnetic body and the second magnetic body is greater than the coercive force of the other magnetic body, and thus the holding force can be improved while suppressing the cogging torque.

Further, in this case, the first magnetic body and the third magnetic body fixed to the shaft have a shape having a constant diameter over the entire circumference in the circumferential direction, in other words, have a circular shape at the entire circumference in the section perpendicular to the axial direction, and thus it is possible to improve the holding torque without increasing torque ripple, and without increasing noise, vibrations, and the like.

Similarly, the distance between the opposing surfaces of the first magnetic body and the second magnetic body opposing each other is constant over the entire circumference, and thus it is possible to improve the holding torque without increasing torque ripple, and without increasing noise, vibrations, and the like.

The motor of the present invention is not limited to the configurations of the embodiments described above.

For example, in each of the embodiments described above, each configuration presented as a mechanism for generating a holding torque may be selected as appropriate, and arbitrarily combined at the first side and at the second side, or may be applied to only one of the first side and the second side.

As an example, a configuration including the first magnetic body 203 and the second magnetic body 304 according to the third embodiment may be selected as the first side a of the shaft 2, and a configuration including the third magnetic body 703 in the seventh embodiment may be selected as the second side b, and these configurations may be combined.

In addition, as another example, as the third magnetic body at the second side b in the seventh embodiment, a configuration similar to that of the first magnetic body 3 may be used, similar to the first side a, and the frame magnet 4 may serve as the fourth magnetic body opposing the third magnetic body. In this case, the frame magnet 4 is a member of a stator opposing the rotor 6, is also the second magnetic body opposing the first magnetic body, and is also the fourth magnetic body opposing the third magnetic body.

In all the embodiments described above, the examples applied to the so-called brush DC motor of the inner rotor type have been described; however, the present invention is not limited to a motor with such a structure, and may be applied to a motor of an outer rotor type, or may be applied to a brushless motor.

In addition, the motor according to the present invention may be appropriately modified by a person skilled in the art according to conventionally known knowledge. Such modifications are of course included in the scope of the present invention as long as these modifications still include the configuration of the present invention.

### REFERENCE SIGNS LIST

1, 201, 301, 401, 501, 601, 701 Motor
1a Housing
1b Amateur (rotating body)
2 Shaft
3, 203, 403, 503 First magnetic body (first magnet)
4 Frame magnet (second magnetic body, second magnet)
5 Commutator
6 Rotor (rotating body)
10 Frame
10a Protruding part
10b Bottom part (end part of frame 10 at first end part 10x side)
10x First end part
10y Second end part
11 Power supply connecting part
12 Brush
13 End plate
14 Circuit board
15 Bracket
16 Power supply terminal
17 Sensor
20 Power supply unit
21 First bearing part
22 Second bearing part
22a Flat surface
23 Disk
51 Support part
52 Commutator piece
53 Riser
54 Varistor
61 Rotating body core
204 Drive magnet
304 Magnetic member (second magnetic body)
503a Flat surface
581, 681 Loose washer (sliding member)
581a, 681a Sliding surface
682 Coil spring (urging member)
703 Third magnet

1. A motor comprising:
a shaft;
a rotating body fixed to the shaft;
a first magnetic body fixed to the shaft; and
a stationary part comprising a second magnetic body, wherein
one of the first magnetic body and the second magnetic body include a magnet, and
the first magnetic body opposes the second magnetic body over an entire circumference.

2. The motor according to claim 1, wherein
the first magnetic body and the second magnetic body oppose each other in a radial direction, and
a distance between opposing surfaces of the first magnetic body and the second magnetic body opposing each other is constant over the entire circumference.

3. The motor according to claim 1, wherein
the first magnetic body and the second magnetic body oppose each other in an axial direction, and
opposing surfaces of the first magnetic body and the second magnetic body opposing each other are flat surfaces.

4. The motor according to claim 2, wherein
the opposing surfaces of the first magnetic body and the second magnetic body include magnetic pole parts.

5. The motor according to claim 1, wherein
the opposing surfaces of the first magnetic body and the second magnetic body include magnetic pole parts, and
the first magnetic body urges the shaft in an axial direction by a magnetic force between the first magnetic body and the second magnetic body.

6. The motor according to claim 5, further comprising:
a sliding member including a sliding surface in contact with a flat surface of the first magnetic body, wherein
the first magnetic body includes the flat surface perpendicular to the axial direction and
the second magnetic body is urged to the sliding member by a magnetic force between the first magnetic body and the second magnetic body.

7. The motor according to claim 1, further comprising:
a frame, wherein
the opposing surfaces of the first magnetic body and the second magnetic body respectively include a magnetic pole part, and
the second magnetic body is a second magnet fixed to an inner circumferential surface of the frame.

8. The motor according to claim 4, wherein
the second magnet opposes the rotating body as a member of a stator.

9. The motor according to claim 1, wherein
the first magnetic body is a first magnet and contains aluminum, nickel, and cobalt, and
the second magnetic body is a second magnet and contains iron.

10. The motor according to claim 1, wherein
the first magnetic body is disposed at a first end side of the shaft, and
an urging member configured to urge the shaft in an axial direction is disposed at a second end side of the shaft.

11. The motor according to claim 10, further comprising:
a fixing member fixed to the shaft and including a flat surface perpendicular to the axial direction; and
a sliding member including a sliding surface in contact with the flat surface of the fixing member in the axial direction, wherein
the urging member urges the sliding member in a direction of the fixing member to urge the shaft in the axial direction.

12. The motor according to claim 1, further comprising:
a third magnetic body fixed to a second end side of the shaft; and
a fourth magnetic body opposing the third magnetic body wherein
the first magnetic body is disposed at a first end side of the shaft.

13. The motor according to claim 12, wherein
the third magnetic body urges the shaft in the axial direction by a magnetic force between the third magnetic body and the fourth magnetic body.

14. The motor according to claim 1, wherein
a strength of a magnetic field of one magnetic body among the first magnetic body and the second magnetic body being exerted on the other magnetic body is greater than a coercive force of the other magnetic body.
